(19) United States
(12) Patent Application Publication
(10) Pub. No.: US 2025/0309520 A1
(43) Pub. Date: Oct. 2, 2025

(54) CAVITY ANTENNA AND ELECTRONIC DEVICE

(71) Applicant: Lenovo (Beijing) Limited, Beijing (CN)

(72) Inventors: Shumin LIAO, Beijing (CN); Chen SU, Beijing (CN)

(21) Appl. No.: 19/094,556

(22) Filed: Mar. 28, 2025

(30) Foreign Application Priority Data
Mar. 29, 2024 (CN) 202410384167.6

(51) Int. Cl. H01Q 1/22; H01Q 9/04

(52) U.S. Cl. CPC H01Q 1/22; H01Q 9/0414; H01Q 9/0485

(57) ABSTRACT

A cavity antenna includes a first conductor, a second conductor, and a third conductor. The second conductor is disposed oppositely to the first conductor, and the second conductor includes a first side, a second side opposite to the first side, a third side, and a fourth side opposite to the third side. The third conductor connects the first conductor and the first side, such that the first conductor, the second conductor and the third conductor enclose a cavity, and the cavity includes a plurality of openings on other sides of the second conductor except the first side.

### CROSS-REFERENCES TO RELATED APPLICATIONS

The present disclosure claims priority of Chinese Patent Application No. 202410384167.6, filed on Mar. 29, 2024, the entire content of which is hereby incorporated by reference.

### FIELD OF THE DISCLOSURE

The present disclosure generally relates to the field of communication equipment technology and, more particularly, relates to a cavity antenna and an electronic device.

### BACKGROUND

Nowadays, to meet users' demand for integrating more functions into an electronic device, more electronic components need to be integrated into limited space of the electronic device, resulting in smaller installation space for an antenna. In addition, demand for miniaturization and lightweight design of the electronic device may further compress the installation space of the antenna. The smaller installation space may result in smaller spacings between the antenna and metal parts of the electronic device, and communication performance of the antenna may be affected.

### SUMMARY

One aspect of the present disclosure includes a cavity antenna. The cavity antenna includes a first conductor, a second conductor, and a third conductor. The second conductor is disposed oppositely to the first conductor, and the second conductor includes a first side, a second side opposite to the first side, a third side, and a fourth side opposite to the third side. The third conductor connects the first conductor and the first side, such that the first conductor, the second conductor and the third conductor enclose a cavity, and the cavity includes a plurality of openings on other sides of the second conductor except the first side.

Another aspect of the present disclosure includes an electronic device. The device includes a cavity antenna. The cavity antenna includes a first conductor, a second conductor, and a third conductor. The second conductor is disposed oppositely to the first conductor, and the second conductor includes a first side, a second side opposite to the first side, a third side, and a fourth side opposite to the third side. The third conductor connects the first conductor and the first side, such that the first conductor, the second conductor and the third conductor enclose a cavity, and the cavity includes a plurality of openings on other sides of the second conductor except the first side.

Other aspects of the present disclosure may be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a three-dimensional schematic diagram of a cavity antenna consistent with the disclosed embodiments of the present disclosure;

FIG. 2 illustrates a side view of the cavity antenna shown in FIG. 1 toward a third side, consistent with the disclosed embodiments of the present disclosure;

FIG. 3 illustrates a top view of the cavity antenna shown in FIG. 1, consistent with the disclosed embodiments of the present disclosure;

FIG. 4 illustrates a three-dimensional schematic diagram of another cavity antenna consistent with the disclosed embodiments of the present disclosure;

FIG. 5 illustrates a three-dimensional schematic diagram of another cavity antenna consistent with the disclosed embodiments of the present disclosure;

FIG. 6 illustrates a front view of the cavity antenna shown in FIG. 5 toward a first side, consistent with the disclosed embodiments of the present disclosure;

FIG. 7 illustrates a top view of the cavity antenna shown in FIG. 5, consistent with the disclosed embodiments of the present disclosure;

FIG. 8 illustrates a schematic layout diagram of a feed point and a ground point in a cavity antenna consistent with the disclosed embodiments of the present disclosure;

FIG. 9 illustrates a three-dimensional schematic diagram of another cavity antenna consistent with the disclosed embodiments of the present disclosure;

FIG. 10 illustrates a side view of the cavity antenna shown in FIG. 9 toward a third side, consistent with the disclosed embodiments of the present disclosure;

FIG. 11 illustrates a top view of the cavity antenna shown in FIG. 9, consistent with the disclosed embodiments of the present disclosure;

FIG. 12 illustrates a three-dimensional schematic diagram of another cavity antenna consistent with the disclosed embodiments of the present disclosure;

FIG. 13 illustrates a reflection coefficient curve of a cavity antenna consistent with the disclosed embodiments of the present disclosure;

FIG. 14 illustrates an efficiency curve of a cavity antenna consistent with the disclosed embodiments of the present disclosure;

FIG. 15 illustrates a partial top view of an electronic device consistent with the disclosed embodiments of the present disclosure; and

FIG. 16 illustrates a cross-sectional view of the electronic device shown in

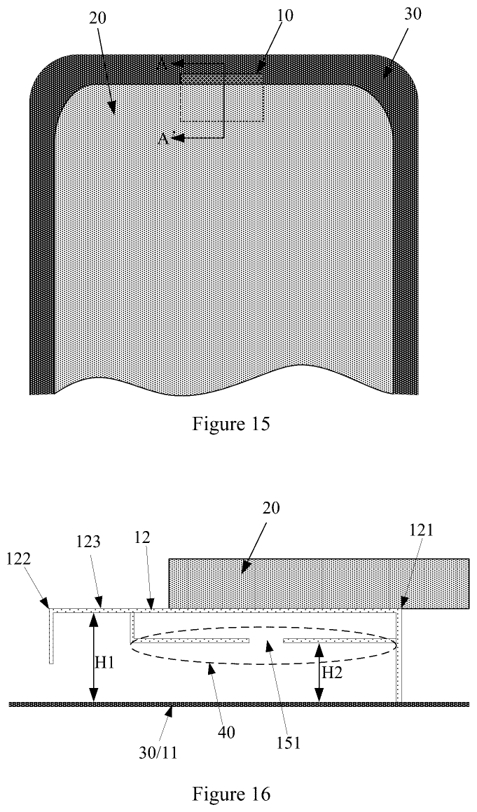

FIG. 15 taken along A-A′ direction, consistent with the disclosed embodiments of the present disclosure.

### DETAILED DESCRIPTION

To make the objectives, technical solutions and advantages of the present disclosure more clear and explicit, the present disclosure is described in further detail with accompanying drawings and embodiments. It should be understood that the specific exemplary embodiments described herein are only for explaining the present disclosure and are not intended to limit the present disclosure.

It should be noted that in the present disclosure, relational terms such as “first” and “second” are only configured to distinguish one entity or operation from another entity or operation, and do not necessarily require or imply that such actual relationship or sequence exists between these entities or operations. Terms “comprise”, “include” or any other variations thereof are intended to cover a non-exclusive inclusion. A process, method, article, or apparatus that includes a series of elements includes not only the series of elements, but also other elements not expressly listed, or elements inherent to such a process, method, article, or apparatus. Without further limitation, an element defined by a statement like “comprises a . . . ” does not exclude the presence of additional identical elements in a process, method, article, or apparatus that includes the foregoing element.

It should be noted that relative arrangements of components and operations, numerical expressions and numerical values set forth in exemplary embodiments are for illustration purposes only and are not intended to limit the present disclosure unless otherwise specified. Techniques, methods and apparatus known to the skilled in the relevant art may not be discussed in detail, but these techniques, methods and apparatus should be considered as a part of the specification, where appropriate.

An antenna in an electronic device may be affected not only by metal components inside the electronic device, but also by a metal back cover outside the electronic device. Nowadays, most electronic devices use metal back covers to improve the texture of the electronic devices, and to improve the strength of the electronic devices such that thin and light designs for the electronic devices may be achieved. The metal back covers may shield internal antennas, and performance of the internal antennas may thus be affected.

By increasing the spacings between metal components inside an antenna electronic device, the antenna clearance may be increased and the impact of internal metal components on antenna performance may be reduced. This may require that there be sufficiently large antenna installation space inside the electronic device. However, as an electronic device needs to integrate more functions and meet the lightweight and miniaturization requirements, the installation space of an antenna in an electronic device may be relatively small. As such, it may be difficult to achieve the above purpose by increasing the antenna installation space in the internal space of an electronic device.

To reduce the impact of the metal back cover on antenna performance, one approach is to set the antenna in the black border area outside the display area on the front of the device. However, electronic devices may have narrow bezel designs, and the width of the black border area is generally about 6-7 mm. In addition, the side and bottom of the area where the antenna is located may also be made of metal. Accordingly, the electromagnetic environment of the antenna may be still poor, and antenna impedance matching may be difficult. As such, the antenna bandwidth may be limited, and may be generally narrow. In addition, since the antenna is surrounded by a large area of metal, the antenna efficiency may be poor, and signal transmission may thus be affected.

To reduce the impact of the metal back cover on antenna performance, another approach is to set the antenna in the rear camera area of the electronic device. The metal back cover needs to have a window in the rear camera area to expose the rear camera for lighting and imaging of the rear camera. This approach may solve the impact of the metal back cover on the antenna. However, circuits and electronic components in the camera module in the rear camera area may cause interference to the antenna.

To address the above problems, the present disclosure provides a cavity antenna suitable for small installation space. The cavity antenna includes a first conductor, a second conductor and a third conductor. The first conductor serves as a carrier, such that the second conductor may be fixedly connected to the first conductor through the third conductor. The second conductor may be connected to the third conductor at the first side, and may thus be fixed on the surface of the first conductor through the third conductor. A cavity may be constructed based on the three conductors. Since the cavity may have openings between the first conductor and the sides of the second conductor except the first side of the second conductor, a cavity antenna with openings on three sides may be formed.

The cavity antenna may use the opening of the cavity to radiate energy, and may have strong radiation performance. As such, the cavity antenna may still have good radiation performance in small installation space. In addition, the cavity antenna may use the metal back cover as part of the cavity antenna, the impact of metal parts of electronic equipment on antenna performance may be reduced. Accordingly, the cavity antenna may be suitable for small installation space, and may have low requirements on the size of the installation space.

Moreover, since the cavity antenna has a cavity structure with openings on three sides, open boundary conditions may be formed. As such, miniaturization designs of the antenna may be achieved, and size requirements for the installation space of the cavity antenna may be further reduced.

It may be seen from the above description that the cavity antenna provided by the present disclosure may be suitable for installation space with a small size. In small installation space, based on the characteristics of cavity resonance and the radiation signals of the cavity openings, the impact of metal parts of electronic equipment on the performance of the cavity antenna may be reduced. In addition, the cavity antenna may have a relatively small size.

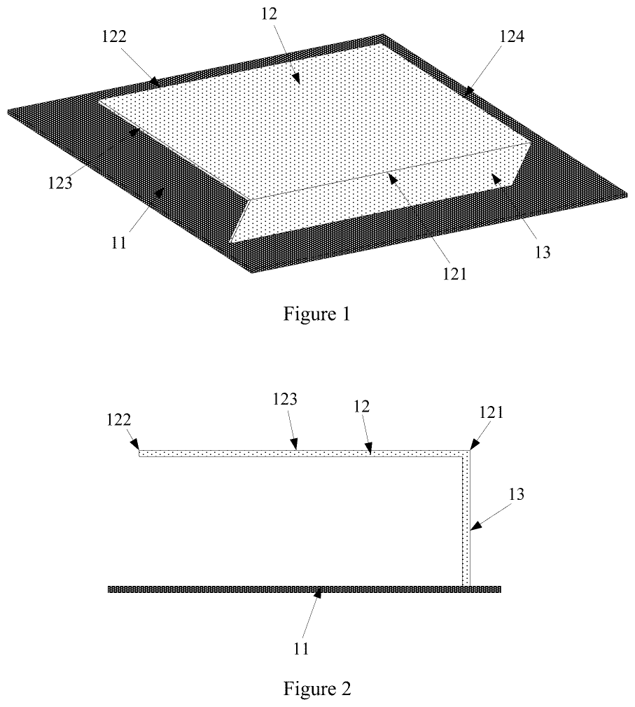

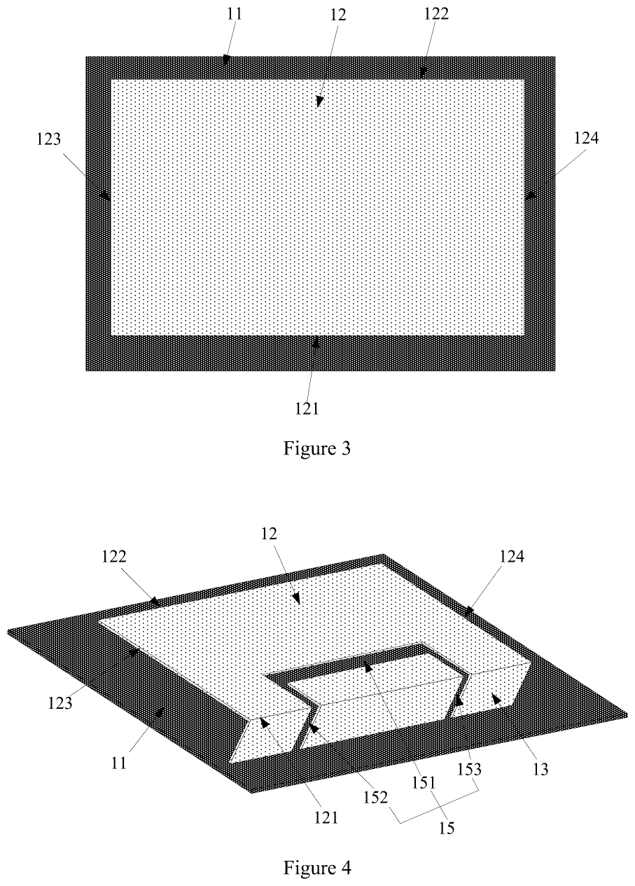

FIG. 1 illustrates a three-dimensional schematic diagram of a cavity antenna consistent with the disclosed embodiments of the present disclosure. FIG. 2 illustrates a side view of the cavity antenna shown in FIG. 1 toward a third side. FIG. 3 illustrates a top view of the cavity antenna shown in FIG. 1. As shown in FIGS. 1-3, the cavity antenna includes: a first conductor 11, a second conductor 12, and a third conductor 13.

The second conductor 12 is disposed oppositely to the first conductor 11. The second conductor 12 includes a first side 121, a second side 122 opposite to the first side 121, a third side 123, and a fourth side 124 opposite to the third side 123.

The third conductor 13 connects the first conductor 11 and the first side 121, such that the first conductor 11, the second conductor 12 and the third conductor 13 enclose a cavity. The cavity may have more than one opening on other sides of the second conductor 12.

The second conductor 12 and the third conductor 13 are constructed as a bent structure fixed on the surface of the first conductor 11. In the bent structure, the second conductor 12 is arranged opposite to the first conductor 11, and the third conductor 13 is respectively connected and fixed to the first side 121 and the first conductor 11. In the cavity antenna provided by the present disclosure, the cavity is constructed by the first conductor 11, the second conductor 12 and the third conductor 13. The cavity has an opening between the second side 122 and the first conductor 11, between the third side 123 and the first conductor 11, and between the fourth side 124 and the first conductor 11, respectively. Accordingly, the cavity antenna having a cavity with openings at three sides may be formed. Based on the cavity structure with openings at three sides, the cavity antenna may form a boundary condition with three sides open. As such, the antenna performance may be improved, and the size of the antenna may be reduced. Accordingly, the miniaturization design of the antenna may be realized, and the size requirement for installation space of the antenna may be reduced.

The cavity antenna may use the openings of the cavity to radiate signals and may have strong radiation performance. As such, the cavity antenna may still have good radiation performance in a small installation space of electronic equipment. The impact of metal parts of the electronic equipment on antenna performance may be reduced. As such, the cavity antenna may be suitable for small installation space, and the size requirements for installation space may be reduced.

The first conductor 11, the second conductor 12 and the third conductor 13 may be an integral structure formed by casting. Alternatively, the second conductor 12 and the third conductor 13 may be an integrated structure, and the integrated structure may be formed by bending a single piece of conductor plate to form a desired structure. The third conductor 13 may be fixed on the surface of the first conductor 11 by welding. Alternatively, the first conductor 11, the second conductor 12 and the third conductor 13 may be three independent conductor plates, and the three independent conductor plates may be fixed by welding to form the required cavity structure.

In one embodiment, the first conductor 11, the second conductor 12 and the third conductor 13 are integrally formed.

In one embodiment, the second conductor 12 and the third conductor 13 are integrally formed. The third conductor 13 is connected to the first conductor 11 by welding, pasting, fixing with a connector, etc.

In one embodiment, the three conductors each are independent parts. The third conductor 13 is connected to the second conductor 12 by welding, pasting, fixing with a connector, etc. The third conductor 13 is connected to the first conductor 11 by welding, pasting, fixing with a connector, etc.

FIG. 4 illustrates a three-dimensional schematic diagram of another cavity antenna consistent with the disclosed embodiments of the present disclosure. As shown in FIG. 4, the second conductor 12 includes a first slit 15. The first slit 15 is configured to divide the second conductor 12 into a first radiation element and a second radiation element. One of the first radiation element and the second radiation element is disposed with a feed point, and the other of the first radiation element and the second radiation element is disposed with a ground point. Based on the feed point and the ground point, the cavity antenna may be connected to a coaxial cable, and then connected to a radio frequency circuit. Accordingly, the cavity antenna may be excited based on the radio frequency circuit.

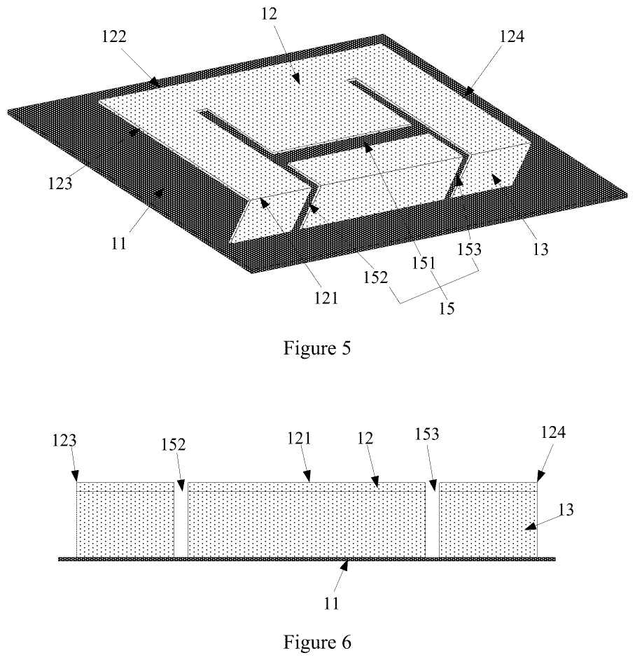

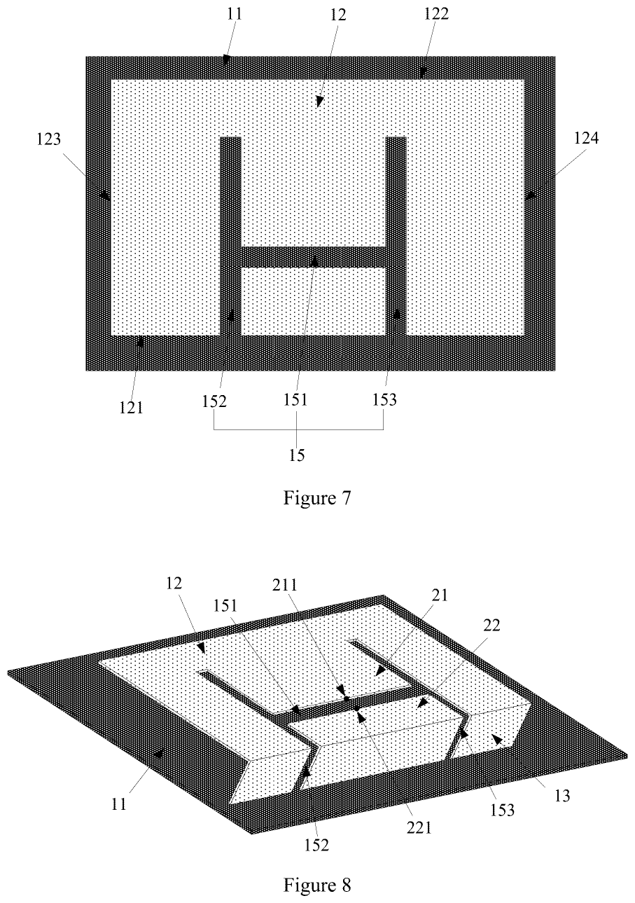

FIG. 5 illustrates a three-dimensional schematic diagram of another cavity antenna consistent with the disclosed embodiments of the present disclosure. FIG. 6 illustrates a front view of the cavity antenna shown in FIG. 5 toward the first side. FIG. 7 illustrates a top view of the cavity antenna shown in FIG. 5. In the cavity antenna shown in FIGS. 5-7, the second conductor 12 includes a first slit 15. The first slit 15 includes: a first sub-slit 151, a second sub-slit 152, and a third sub-slit 153. The first sub-slit 151 is located in the second conductor 12, and the first sub-slit 151 and the first side 121 meet the parallel condition. The second sub-slit 152 is connected to one end of the first sub-slit 151, and the third sub-slit 153 is connected to the other end of the first sub-slit 151. The second sub-slit 152 and the third sub-slit 153 each extend to the first conductor 11 through the first side 121 and the third conductor 13. As such, the second conductor 12 may be divided into a first radiation element and a second radiation element. One of the first radiation element and the second radiation element includes a feed point, and the other of the first radiation element and the second radiation element includes a ground point.

Based on the first slit 15, the path of the current in the second conductor 12 and the third conductor 13 may be lengthened. As such, by setting the pattern structure and size of the first slit 15, the radiation performance of the cavity antenna may be adjusted to meet the communication requirements of the required frequency band and the bandwidth through the cavity antenna.

The feed point and the ground point may be used to connect to a radio frequency circuit through a same coaxial cable. Through the radio frequency circuit, the cavity antenna may be excited to radiate signals. The radio frequency circuit may also obtain radio frequency signals received by the cavity antenna through the coaxial cable.

The second sub-slit 152 and the third sub-slit 153 also extend from the first side 121 to the side where the third conductor 13 is fixedly connected to the first conductor 11. The third conductor 13 may be divided into two separate parts corresponding to the first radiation element and the second radiation element. The first radiation element and the second radiation element are respectively, fixedly connected to the surface of the first conductor 11, based on a part of the third conductor 13.

The first side 121 and the second side 122 meet the parallel condition, and the extending direction of the first side 121 and the second side 122 is a first direction. The third side 123 and the fourth side 124 meet the parallel condition, and the extending direction of the third side 123 and the fourth side 124 is a second direction. When two objects satisfy the parallel condition, the two objects are parallel or approximately parallel.

The extending direction of the first sub-slit 151 and the first side 121 is the first direction, such that the first sub-slit 151 and the first side 121 meet the parallel condition.

The parts of the second sub-slit 152 and the third sub-slit 153 in the second conductor 12 each extend along the second direction. The second sub-slit 152 and the third sub-slit 153 each extend from the second conductor 12 to the first side 121, and each extend from the first side 121 through the third conductor 13 to the side where the third conductor 13 is fixedly connected to the first conductor 11.

In the cavity antenna, the area of the first radiation element is greater than the area of the second radiation element. The feed point is set on the first radiation element with a larger area. During excitation, multiple reflections of electromagnetic waves between two opposite reflection surfaces (the first conductor 11 and the first radiation element with a larger area) may be achieved, and directivity may thus be enhanced. In addition, since the first radiation element with the feed point has a larger area, the part of the first slit 15 located in the first radiation element may have large layout space. As such, the part of the first slit 15 located in the first radiation element may be arranged flexibly, and the radiation performance of the cavity antenna may be improved.

FIG. 8 illustrates a schematic layout diagram of a feed point and a ground point in a cavity antenna consistent with the disclosed embodiments of the present disclosure. As shown in FIG. 8, based on the first slit 15, the second conductor 12 may be divided into a first part 21 and a second part 22. The first part 21 surrounds the second part 22. The first part 21 is configured as a first radiation element and is provided with a feed point 211. The second part 22 is configured as a second radiation element and is provided with a ground point 221. The feed point 211 and the ground point 221 are located on two opposite sides of the first sub-slit 151 such that the feed point 211 and the ground point 221 may be connected to a same coaxial cable.

For the cavity antenna with the first slit 15, the connection position between the first sub-slit 151 and the second sub-slit 152 is located between the two ends of the second sub-slit 152. The connection position between the first sub-slit 151 and the third sub-slit 153 is located between two ends of the third sub-slit 153. The second sub-slit 152 and the third sub-slit 153 do not extend to the second side 122. In this way, as shown in FIG. 7, an H-shaped first slit 15 may be formed in the second conductor 12.

For the H-shaped first slit 15, the first sub-slit 151, the part of the second sub-slit 152 located between the first sub-slit 151 and the first side 121, the part of the third sub-slit 153 located between the first sub-slit 151 and the first side 121, and the first side 121 may separate a part of the second conductor 12. As such, the second conductor 12 may be divided into a first radiation element and a second radiation element. In addition, the connection positions of the second sub-slit 152 and the third sub-slit 153 with the first sub-slit 151 each are located between the ends of the second sub-slit 152 and between the ends of the third sub-slit 153, respectively. As such, the second sub-slit 152 and the third sub-slit 153 each have a part extending from the connection position with the first sub-slit 151 toward the second side 122. The second sub-slit 152 and the third sub-slit 153 extending from the connection positions with the first sub-slit 151 to the second side 122 may increase the current path. Accordingly, the impedance of the 5G and 6E frequency bands may be optimized, and the bandwidth of the antenna may be broadened.

In one embodiment, the first slit 15 may be used to divide the second conductor 12 into a first radiation element and a second radiation element. In addition, a recessed portion may also be constructed in the second conductor 12 based on the first slit 15, such that a coaxial cable may be connected to the cavity antenna based on the recessed portion. As such, the height of the connection position between the coaxial cable and the cavity antenna relative to the first conductor 11 may be reduced. Accordingly, the connection position may be prevented from squeezing other components above the cavity antenna (such as a display screen).

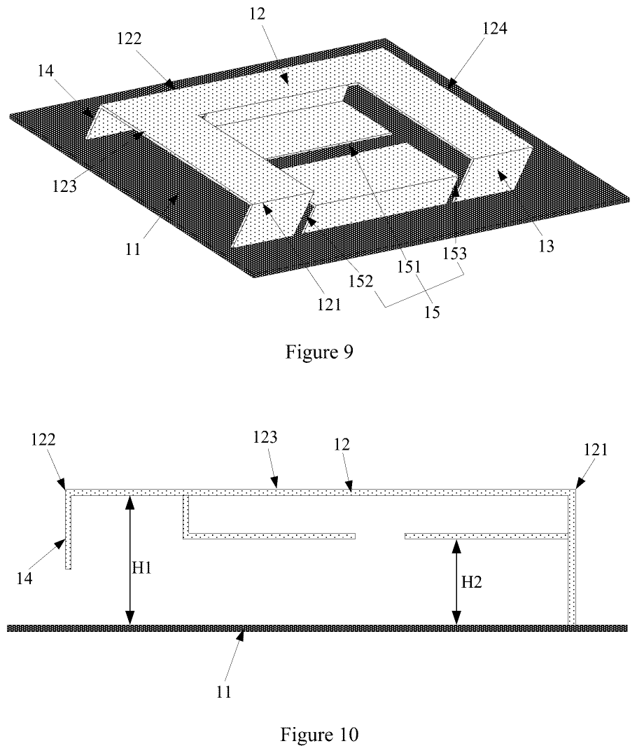

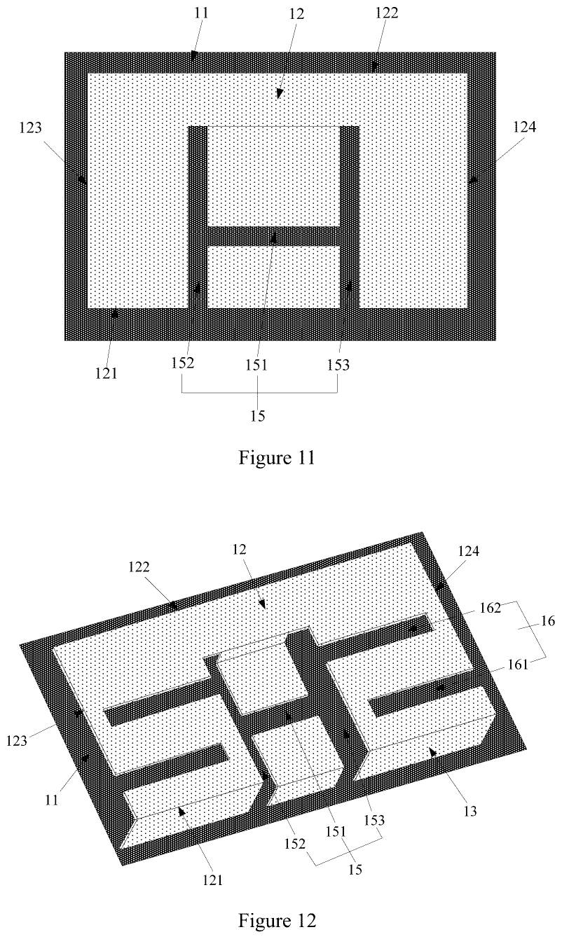

FIG. 9 illustrates a three-dimensional schematic diagram of another cavity antenna consistent with the disclosed embodiments of the present disclosure. FIG. 10 illustrates a side view of the cavity antenna shown in FIG. 9 toward the third side. FIG. 11 illustrates a top view of the cavity antenna shown in FIG. 9. As shown in FIGS. 9-11, the part of the second conductor 12 between the second sub-slit 152 and the third sub-slit 153 forms a recessed portion for connecting a coaxial cable terminal. The other part of the second conductor 12 except the recessed portion has a first height H1 relative to the first conductor 11. The recessed portion has a second height H2 relative to the first conductive member 11. The second height H2 is smaller than the first height H1.

Optionally, the coaxial cable is connected to the first radiation element and the second radiation element at two opposite sides of the first sub-slit 151 respectively.

As shown in FIG. 9 and FIG. 10, the cavity antenna also includes a fourth conductor 14 connected to the second side 122. The fourth conductor 14 is bent relative to the second conductor 12 and toward the first conductor 11, and a spacing exists between the fourth conductor 14 and the first conductor 11. Based on the fourth conductor 14, the area of the radiation element in the cavity antenna may be increased, and the cavity antenna may thus have a larger spatial layout. As such, a longer current path may be achieved, and the antenna bandwidth may be adjusted without increasing the volume and area of the cavity antenna. In addition, the fourth conductor bent toward the first conductor 11 may also optimize the opening size of the cavity on the second side 122. As such, the boundary condition of the opening may be optimized, and the radiation direction of the antenna may be adjusted.

It should be noted that in the present disclosure, the fourth conductor 14 may be provided based on any embodiment of the present disclosure. The fourth conductor 14 is not limited to being used for the cavity antenna with the recessed portion as shown in FIGS. 9 and 10.

As described above, the second conductor 12 may be divided into a first radiation element and a second radiation element based on the first slit 51. The first radiation element may be provided with a feed point, and the second radiation element may be provided with a ground point. Based on the shape and size layout of the first slit 15, the first radiation element in the cavity antenna may operate at a first resonant frequency and a second resonant frequency. The first resonant frequency is lower than the second resonant frequency, where the length of the third side 123 corresponds to ¼ wavelength of the first resonant frequency.

The cavity antenna may be configured such that the length of the third side 123 corresponds to ¼ wavelength of the first resonant frequency. In this way, a radio frequency signal of the first resonance frequency may be radiated based on the third side 123. By setting the size of each side of the second conductor 12, the graphic structure and size of the first slit 15, and the height of the cavity, the communication frequency band corresponding to the first resonant frequency and the second resonant frequency may be set. In one embodiment, the first resonant frequency may correspond to the 2.4G WIFI frequency band, and the second resonant frequency may correspond to the 5G or 6E frequency band.

Further, the length of the second side 122 may be set to be greater than the length of the third side 123. A radio frequency signal of the second resonant frequency may be radiated based on the second side with a greater length, the cavity structure and the first slit 15. The radio frequency signal of the first resonant frequency and the radio frequency signal of the second resonant frequency correspond to different communication frequency bands respectively. Accordingly, the cavity antenna may have advantages including dual frequency and high bandwidth.

In one embodiment, the cavity antenna may radiate a radio frequency signal of the first resonant frequency based on the third side 123 and/or the fourth side 124.

FIG. 12 illustrates a three-dimensional schematic diagram of another cavity antenna consistent with the disclosed embodiments of the present disclosure. As shown in FIG. 12, the cavity antenna may also include a second slit 16. The second slit 16 is disposed between the third side 123 and the adjacent second sub-slit 152, and/or between the fourth side 124 and the adjacent third sub-slit 153, to increase the antenna feeding current path. The second slit and the first side meet the parallel condition. Since the second slit 16 may lengthen the current path in the second conductor 12, a radio frequency signal of a required frequency band may be realized with a smaller antenna size.

Optionally, the second slit 16 includes a fourth sub-slit 161 and a fifth sub-slit 162 that are arranged in parallel. For the second slit 16 located between the third side 123 and the second sub-slit 152, one end of the fourth sub-slit 161 is located at the third side 123 and the other end is not connected to the second sub-slit 152, and one end of the fifth sub-slit 162 is connected to the second sub-slit 152 and the other end is not connected to the third side 123. For the second gap 16 located between the fourth side 124 and the third sub-slit 153, one end of the fourth sub-slit 161 is located at the fourth side 124 and the other end is not connected to the third sub-slit 153, and one end of the fifth sub-slit 162 is connected to the third sub-slit 153 and the other end is not connected to the fourth side 124.

When the second slit 16 is disposed between the third side 123 and the adjacent second sub-slit 152, the second slit 16 may lengthen the path of current transmitted based on the third side 123. Similarly, when the second slit 16 is disposed between the fourth side 124 and the adjacent third sub-slit 153, the second slit 16 may lengthen the path of current transmitted based on the fourth side 124. Accordingly, the cavity antenna may reduce the size of the two shorter sides of the cavity antenna based on the second slit 16, thereby realizing the miniaturization of the cavity strip line.

A dielectric object may be disposed between the second conductor 12 and the first conductor 11 to improve the radiation performance of the antenna.

A conventional cavity antenna may be formed by removing one long side of a rectangular metal frame to form a cavity antenna with an opening on one long side. The required size of the cavity antenna with this structure may often be large, with the cavity length being approximately half of the wavelength of the resonant frequency and the cavity width being approximately quarter of the wavelength of the resonant frequency. In addition, since impedance optimization may be difficult, the cavity antenna with this structure may not cover 2.4G WIFI band and the 5G band simultaneously.

Compared with the conventional cavity antenna described above, the cavity antenna provided by the present disclosure is based on a cavity with openings at three sides. As such, the boundary conditions of the cavity may be optimized and adjusted. The cavity antenna may form an open boundary with openings at a plurality of sides. As a result, the resonance of the antenna in the low frequency band (such as the 2.4G WIFI band) may be changed from half of the wavelength on the long side to quarter of the wavelength on the short side, thereby achieving miniaturization of the antenna. In addition, further miniaturization of the antenna may be achieved by depositing the second slit 16. Accordingly, the cavity antenna provided by the present disclosure may cover 2.4G/5G/6E, and the antenna in-band efficiency may be within approximately −2 dB.

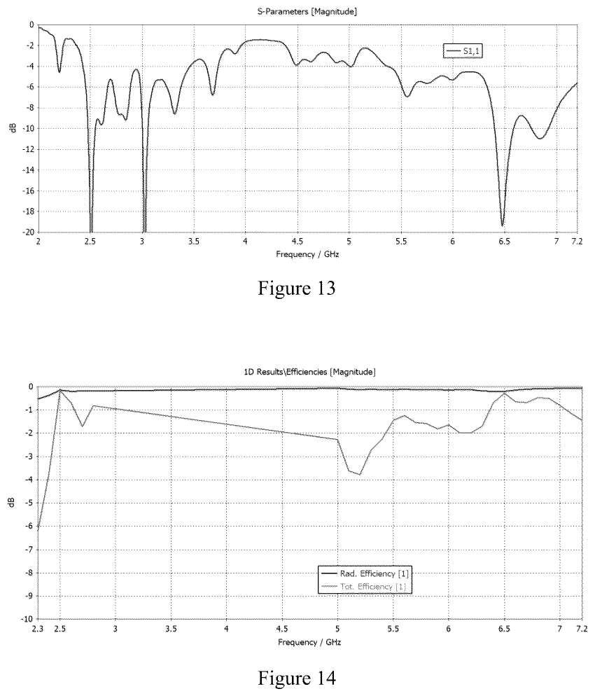

FIG. 13 illustrates a reflection coefficient curve of a cavity antenna consistent with the disclosed embodiments of the present disclosure. FIG. 14 illustrates an efficiency curve of a cavity antenna consistent with the disclosed embodiments of the present disclosure. Based on the curves shown in FIGS. 13 and 14, it may be seen that the reflection coefficient and efficiency of the cavity antenna provided in the present disclosure may meet the normal communication performance requirements of antennas.

The present disclosure also provides an electronic device. The electronic device includes a cavity antenna provided by the present disclosure. The electronic device may adopt a cavity antenna implemented in any embodiment of the present disclosure.

FIG. 15 illustrates a partial top view of an electronic device consistent with the disclosed embodiments of the present disclosure. FIG. 16 illustrates a cross-sectional view of the electronic device shown in FIG. 15 taken along A-A′ direction. As shown in FIGS. 15 and 16, the electronic device includes a cavity antenna 10. For the structure of the cavity antenna 10, reference may be made to the embodiments of the present disclosure. The electronic device includes a metal back cover 30.

In one embodiment, as shown in FIG. 16, the metal back cover 30 may be multiplexed as the first conductor 11. In this case, the bent structure formed by the second conductor 12 and the third conductor 13 may be directly fixed on the inner surface of the metal back cover 30. That is, the cavity antenna may be integrated into the electronic device. In this way, the metal back cover of the electronic device may be multiplexed as a part of the cavity antenna, and the integration level of the electronic device may thus be improved.

In some other embodiments, a surface of the first conductor 11 facing away from the second conductor 12 may be fixed to the inner surface of the metal back cover 30.

As shown in FIGS. 15 and 16, the electronic device includes a display screen 20. The display screen 20 is located inside the metal back cover 30 and there exists a frame area between the display screen 20 and the edge portion of the metal back cover 30. A portion of the cavity antenna 10 is located below the display screen 20 and is blocked by the display screen (such as the area surrounded by the dotted line in FIG. 15), and another portion is located in the frame area and is not blocked by the display screen 20.

The display screen 20 exposes a part of the cavity antenna 10, and the part of the cavity antenna 10 is disposed in the frame area not blocked by the display screen 20. In this way, a part of the cavity antenna may be disposed in the space between the display screen 20 and the metal back cover 30, and another part of the cavity antenna 10 may be disposed in the frame area not blocked by the display screen. The cavity antenna 10 may also radiate signals toward the display side of the electronic device based on the frame area where the cavity antenna 10 is located. In addition, since the part of the cavity antenna 10 located in the frame area is at a relatively small spacing from the adjacent side of the metal cover, the radio frequency signal radiated by the cavity antenna 10 may bypass the metal back cover 30 and radiate toward the back of the electronic device.

As shown in FIGS. 15 and 16, the electronic device includes a display screen 20. The cavity antenna 10 may be disposed on the back of the display screen 20. The first conductor 11 may be located on a side of the second conductor 12 away from the display screen 20.

The second conductor 12 may have a recessed portion 40 for connecting a coaxial cable terminal. The height of the other part of the second conductor 12 except the recessed portion 40 relative to the first conductor is in the range of approximately 3 mm to 4 mm. That is, the range of the first height H1 is approximately 3 mm to 4 mm. The height of the recessed portion 40 relative to other portions is in the range of approximately 1 mm to 1.5 mm, that is, the value of (H1−H2) is in a range of approximately 1 mm to 1.5 mm.

A coaxial cable may be connected to the cavity antenna at the recessed portion 40. The coaxial cable may be located on two adjacent conductive sides of the first sub-slit 151, with the inner conductor and the outer conductor of the coaxial able connected to the feed point and the ground point, respectively.

The electronic device may adopt the cavity antenna 10 provided in the present disclosure. The cavity antenna 10 includes a cavity structure with openings on three sides. Accordingly, the deterioration effect of the metal back cover 30 on the antenna radiation performance in the electronic device may be minimized.

In addition, a first slit 15 with a relatively closed structure may be formed in the cavity antenna 10. As such, the electromagnetic wave loss of the cavity antenna 10 may be less than the electromagnetic wave loss of a conventional small antenna, and the antenna efficiency may thus be improved. The antenna size of the cavity antenna 10 may be optimized based on the H-shaped first slit 15 to optimize the impedance in the 5G/6E frequency band. As such, the bandwidth of the antenna may be broadened.

In the electronic device, the cavity antenna 10 may be slitted to form a second slit 16 based on the current distribution in the 2.5G frequency band and the current transmission direction along the third side 123/the fourth side 124. The second slit 16 may be perpendicular to the current transmission direction and may cut off the current transmission path on the third side 123/the fourth side 124. Accordingly, the current transmission path may be lengthened, and the miniaturization of the antenna may be achieved.

In addition, due to the multiplexity of the cavity antenna 10, the cavity antenna 10 may be used in different electronic devices, including but not limited to laptops, tablet computers, mobile phones, wearable devices and other electronic devices with wireless communication functions.

As disclosed, the technical solutions of the present disclosure have the following advantages.

The cavity antenna provided by the present disclosure includes a first conductor, a second conductor and a third conductor. The first conductor serves as a carrier, such that the second conductor may be fixedly connected to the first conductor through the third conductor. The second conductor may be connected to the third conductor at the first side, and may thus be fixed on the surface of the first conductor through the third conductor. A cavity may be constructed based on the three conductors. Since the cavity may have openings between the first conductor and the sides of the second conductor except the first side of the second conductor, a cavity antenna with openings on three sides may be formed. The cavity antenna may use the openings of the cavity to radiate energy, and the impact of metal parts of electronic equipment on antenna performance may be reduced. Moreover, since the cavity antenna has a cavity structure with openings on three sides, open boundary conditions may be formed. Accordingly, miniaturization designs of the antenna may be achieved.

The cavity antenna provided by the present disclosure may be installed in a small space. Based on the characteristics of cavity resonance and the radiation signals of the cavity openings, the impact of metal parts of electronic equipment on the performance of the cavity antenna may be reduced. In addition, the cavity antenna may have a relatively small size.

The embodiments disclosed in the present disclosure are exemplary only and not limiting the scope of the present disclosure. Various combinations, alternations, modifications, or equivalents to the technical solutions of the disclosed embodiments may be obvious to those skilled in the art and may be included in the present disclosure. Without departing from the spirit of the present disclosure, the technical solutions of the present disclosure may be implemented by other embodiments, and such other embodiments are intended to be encompassed within the scope of the present disclosure.

What is claimed is:

1. A cavity antenna, comprising:
a first conductor;
a second conductor, wherein the second conductor is disposed oppositely to the first conductor, and the second conductor includes a first side, a second side opposite to the first side, a third side, and a fourth side opposite to the third side; and
a third conductor, wherein the third conductor connects the first conductor and the first side, such that the first conductor, the second conductor and the third conductor enclose a cavity, and the cavity includes a plurality of openings on other sides of the second conductor except the first side.

2. The antenna according to claim 1, wherein:
the second conductor includes a first slit, and the first slit includes a first sub-slit, a second sub-slit, and a third sub-slit,
wherein:
the first sub-slit is located in the second conductor, and the first sub-slit and the first side meet parallel conditions;
the second sub-slit is connected to one end of the first sub-slit, and the third sub-slit is connected to other end of the first sub-slit;
the second sub-slit and the third sub-slit each extend to the first conductor through the first side and the third conductor, thereby dividing the second conductor into a first radiation element and a second radiation element; and
one of the first radiation element and the second radiation element includes a feed point, and other of the first radiation element and the second radiation element includes a ground point.

3. The antenna according to claim 2, wherein:
a connection position between the first sub-slit and the second sub-slit is located between two ends of the second sub-slit;
a connection position between the first sub-slit and the third sub-slit is located between two ends of the third sub-slit; and
the second sub-slit and the third sub-slit are not connected to the second side.

4. The antenna according to claim 3, wherein:
a part of the second conductor between the second sub-slit and the third sub-slit forms a recessed portion for connecting a coaxial cable terminal;
other parts of the second conductor except the recessed portion have a first height relative to the first conductor; and
the recessed portion has a second height relative to the first conductive member, and the second height is less than the first height.

5. The antenna according to claim 2, wherein:
the first radiation element in the cavity antenna operates at a first resonant frequency and a second resonant frequency, wherein the first resonant frequency is lower than the second resonant frequency; and
a length of the third side corresponds to approximately 1/4 wavelength of the first resonant frequency.

6. The antenna according to claim 2, further comprising a second slit, wherein:
the second slit is located between the third side and the second sub-slit that is adjacent to the third side, and/or between the fourth side and the third sub-slit that is adjacent to the fourth side; and
the second slit and the first side meet parallel conditions.

7. The antenna according to claim 6, wherein:
the second slit includes a fourth sub-slit and a fifth sub-slit that is parallel to the fourth sub-slit;
for the second slit located between the third side and the second sub-slit, one end of the fourth sub-slit is located at the third side and other end of the fourth sub-slit is not connected to the second sub-slit, and one end of the fifth sub-slit is connected to the second sub-slit and other end of the fifth sub-slit is not connected to the third side; and
for the second gap located between the fourth side and the third sub-slit, one end of the fourth sub-slit is located at the fourth side and other end of the fourth sub-slit is not connected to the third sub-slit, and one end of the fifth sub-slit is connected to the third sub-slit and other end the fifth sub-slit is not connected to the fourth side.

8. The antenna according to claim 1, wherein:
the first conductor, the second conductor and the third conductor are integrally formed.

9. The antenna according to claim 1, wherein:
the second conductor and the third conductor are integrally formed, and the third conductor is fixedly connected to the first conductor.

10. The antenna according to claim 1, wherein:
the first conductor, the second conductor and the third conductor each are independently formed;
the third conductor is fixedly connected to the second conductor; and
the third conductor is fixedly connected to the first conductor.

11. The antenna according to claim 2, wherein:
the second sub-slit and the third sub-slit each extend from the first side to a side where the third conductor is fixedly connected to the first conductor, dividing the third conductor into two parts corresponding to the first radiation element and the second radiation element respectively; and
the first radiation element and the second radiation element are respectively fixedly connected to a surface of the first conductor through one of the two parts of the third conductor.

12. The antenna according to claim 2, wherein:
the first side and the second side meet parallel conditions, and extending directions of the first side and the second side are a first direction; and
the third side and the fourth side meet parallel conditions, and extending directions of the third side and the fourth side are a second direction.

13. The antenna according to claim 12, wherein:
an extending direction of the first sub-slit is the first direction; and
the second sub-slit and the third sub-slit each extend, along the second direction, from the second conductor to the first side, and then extend from the first side through the third conductor to a side where the third conductor is fixedly connected to the first conductor.

14. The antenna according to claim 2, wherein:
an area of the first radiation element is greater than an area of the second radiation element; and
the feed point is disposed on the first radiation element.

15. The antenna according to claim 4, further comprising a fourth conductor, wherein:
the fourth conductor is bent relative to the second conductor and toward the first conductor, and a spacing exists between the fourth conductor and the first conductor.

16. The antenna according to claim 1, wherein:
a dielectric object is disposed between the second conductor and the first conductor.

17. An electronic device, comprising a cavity antenna, wherein the cavity antenna includes:
a first conductor;
a second conductor, wherein the second conductor is disposed oppositely to the first conductor, and the second conductor includes a first side, a second side opposite to the first side, a third side, and a fourth side opposite to the third side; and
a third conductor, wherein the third conductor connects the first conductor and the first side, such that the first conductor, the second conductor and the third conductor enclose a cavity, and the cavity includes a plurality of openings on other sides of the second conductor except the first side.

18. The device according to claim 17, further comprising a metal back cover, wherein:
the metal back cover is multiplexed as the first conductor; or
a surface of the first conductor facing away from the second conductor is fixed to an inner surface of the metal back cover.

19. The device according to claim 17, further comprising a display screen, wherein:
the cavity antenna is disposed on a back of the display screen, and the first conductor is located on a side of the second conductor away from the display screen.

20. The device according to claim 19, wherein:
the second conductor includes a recessed portion for connecting a coaxial cable terminal, wherein a height of other portions of the second conductor except the recessed portion relative to the first conductor is in a range of approximately 3 mm to 4 mm, and a sinking height of the recessed portion relative to the other portions is in a range of approximately 1 mm to 1.5 mm.
